(19) United States
(12) Patent Application Publication
(10) Pub. No.: US 2010/0199505 A1
(43) Pub. Date: Aug. 12, 2010

(54) Cutting Blade Holder for a Microsurgical Cutting Arrangement, in particular such an Arrangement for Refractive Eye Surgery

(75) Inventors: Christof Donitzky, Eckental (DE); Daniel Thimm, Schwanstetten (DE)

Correspondence Address: HAYNES AND BOONE, LLP;IP Section, 2323 Victory Avenue, Suite 700, Dallas, TX, 75219, US

(73) Assignee: Wavelight AG, Erlangen (DE)

(21) Appl. No.: 12/063,592

(22) PCT Filed: Aug. 3, 2006
(86) PCT No.: PCT/EP06/07700

§ 371 Date: Apr. 30, 2010

(30) Foreign Application Priority Data
Aug. 12, 2005 (EP) 05017648.6

(51) Int. Cl. B25G 3/00

(52) U.S. Cl. 30/342

(57) ABSTRACT

A cutting blade holder (10) for a microsurgical cutting arrangement, in particular a cutting arrangement for refractive eye surgery, comprises a receptacle (34) into which a cutting blade unit (14) together with a cutting blade (12) can be inserted. For the sideways guidance of the cutting blade unit in the receptacle the cutting blade holder comprises guide means, which in one embodiment include a plurality of guide bars (50, 52, 54, 56) arranged on both sides of the plane of the blade of the cutting blade, by means of which a relatively friction-free linear contact with the cutting blade is produced.

### CROSS REFERENCE

This application was originally filed as Patent Cooperation Treaty Application Number PCT/EP2006/007700 filed Aug. 3, 2006, which claims priority of European Application Number 05017648.6, filed Aug. 12, 2005.

### CROSS-REFERENCE TO RELATED APPLICATION

This application is a United States national phase application of co-pending international patent application number PCT/EP2006/00700, filed Aug. 3, 2006, the disclosure of which is incorporated herein by reference.

### BACKGROUND

The present invention relates to a cutting blade holder for a microsurgical cutting arrangement, in particular a cutting arrangement for refractive eye surgery, in which the cutting blade holder comprises a receptacle into which a cutting blade unit with a cutting blade can be inserted, wherein in addition the cutting blade holder comprises guide means for the lateral guidance of the cutting blade unit in the receptacle.

### SUMMARY

In the refractive correction of defective vision in the human eye it is known to separate a surface flap from the cornea by means of a microsurgical cutting instrument termed a microkeratome, so that the flap is still joined on one side to the cornea by a so-called hinge. By lifting up and folding the flap to one side the underlying corneal regions (stroma) are accessible for reshaping of the cornea by means of a laser. After completion of the laser treatment the flap is folded back in position.

The microkeratome normally comprises a suction ring unit that can be placed on the eyeball (limbus), on which a cutting blade holder replacably loaded with a cutting blade can be movably guided. For the flap preparation the cutting blade holder is moved by means of an electric motor drive in a feed direction over the cornea. At the same time the cutting blade with its front cutting edge projecting from the cutting blade holder cuts into the cornea and detaches the flap.

In addition to the feed of the cutting blade holder the cutting blade is normally caused to execute lateral oscillations. Oscillation frequencies between 15 and 500 Hz, in particular between 100 and 250 Hz, are not unusual in this connection. At these high frequencies of the lateral reciprocatory movement of the cutting blade, the guide means provided in the cutting blade holder should be able to ensure a smooth and low-friction, but none the less precise, guidance of a cutting blade unit comprising the cutting blade in the cutting blade holder.

In this respect, in a cutting blade holder of the generic type referred to in the introduction, according to the invention the guide means include guide formations arranged on both sides of the plane of the blade, the formations producing an approximately punctiform or linear (line) contact with the cutting blade. As a result of the direct guidance of the flat sides of the cutting blade on the guide means a high precision in guiding the blade can be achieved. The punctiform or linear contact of the blade with the guide means provides a low level of friction and correspondingly also a low wear, which in turn has a favourable effect on the constancy of the extremely high cutting accuracy that is generally necessary, particularly in ophthalmological operations. When a punctiform or linear contact is referred to in this connection, this means that, on account of micro deformations of the structural parts in contact with one another and on account of the never perfectly ideally smooth surfaces of these structural parts, a punctiform or linear contact between the cutting blade and the guide formations does not exist in the strict mathematical sense, but only in the technical sense.

In one embodiment at least one guide formation is formed by a guide bar held on a base body of the cutting blade holder and extending transversely to the blade direction. Overall a plurality of such guide bars can be provided without any problem above and/or below the cutting blade in the receptacle.

A plurality of guide formations can if necessary also be formed in one piece on a common guide body of the cutting blade holder. For example, at least one guide plate could be inserted into the receptacle, which guide plate carries on its side facing towards the cutting edge an arrangement of locally projecting guide knobs that per se produce in each case an approximately punctiform contact with the cutting blade. Alternatively a plurality of elongated guide ribs that in each case produce a linear contact with the cutting blade could be formed on a common guide body, wherein this guide body can be a structural part produced separately from a base body of the cutting blade holder or can be formed directly from such a base body.

In order to achieve a punctiform or linear contact, at least one guide formation viewed in a cross-section transverse to the transverse direction of the blade can have an arcuately curved or alternatively a cone-shaped contour in the region of a guide bearing point.

The guide formations can be distributed in such a way that at least one pair of guide formations arranged on both sides of the plane of the blade lie at least approximately opposite one another viewed in a cross-section transverse to the transverse direction of the blade. It is however also conceivable for a plurality of guide formations to be arranged alternately on both sides of the plane of the blade, viewed in a cross-section transverse to the transverse direction of the blade.

It is recommended that the guide means associated with each of the flat sides of the cutting blade include at least two guide formations arranged spaced apart from one another in the longitudinal direction of the blade. In this case the guide means can include two guide formations, which when the cutting blade unit is correctly inserted into the receptacle are arranged on both sides of a blade attachment on one of the flat sides of the blade, in the longitudinal direction of the blade.

In order to be able to achieve precisely a required flap thickness, it is advantageous to guide the cutting blade in a supported manner on its rear blade edge on a guide bearing surface of the cutting blade holder. In order also to ensure that this guide contact between the cutting blade and cutting blade holder is relatively friction-free and smooth, the guide bearing surface preferably has a convex, for example arcuately curved contour viewed in a cross-section transverse to the transverse direction of the blade.

It is particularly advantageous for a low degree of wear if the guide means are formed by one or more guide bodies, which are produced separately from a base body of the cutting blade holder and are made of a harder material than the latter.

Typical cutting blades, such as are used in conjunction with a cutting blade holder of the type considered here, are produced by punching from a sheet metal material followed by grinding to form the cutting edge. In this connection it cannot be excluded that fine burrs remain on the lateral edge regions of the blade, which of course are not sharpened. When the cutting blade in its lateral oscillations moves with its lateral edge regions over the guide formations of the cutting blade holder, an abrasion of very fine chips therefore cannot be prevented. Such chips can lead to ocular contamination and should therefore be avoided as far as possible. For this purpose it is recommended that the guide formations be provided in a region whose extension in the transverse direction of the blade is less than the extension of a cutting blade intended and designed for use with the cutting blade holder. If the lateral oscillation stroke of the cutting blade and of the transverse extension of the guide formations or of the region provided with such guide formations are suitably matched, then the cutting blade together with its lateral blade edges can be prevented from moving over the guide formations. Possible chip abrasion on the lateral blade edges can thus be prevented.

### BRIEF DESCRIPTION OF THE DRAWINGS

The invention is described in more detail hereinafter by examples of implementation and with the aid of the accompanying drawings, in which:

FIG. 1 is a section through a blade receptacle region of a cutting blade holder according to an embodiment,

FIG. 2 is a perspective view of an embodiment of a cutting blade unit suitable for use with the cutting blade holder of FIG. 1,

FIGS. 3 to 5 are variants of guide means for guiding a cutting blade of the cutting blade unit of FIG. 2,

FIG. 6 is a sectional representation, similar to FIG. 1, of a further embodiment,

FIG. 7 is a perspective view of part of a cutting blade holder of the embodiment of FIG. 6.

### DETAILED DESCRIPTION

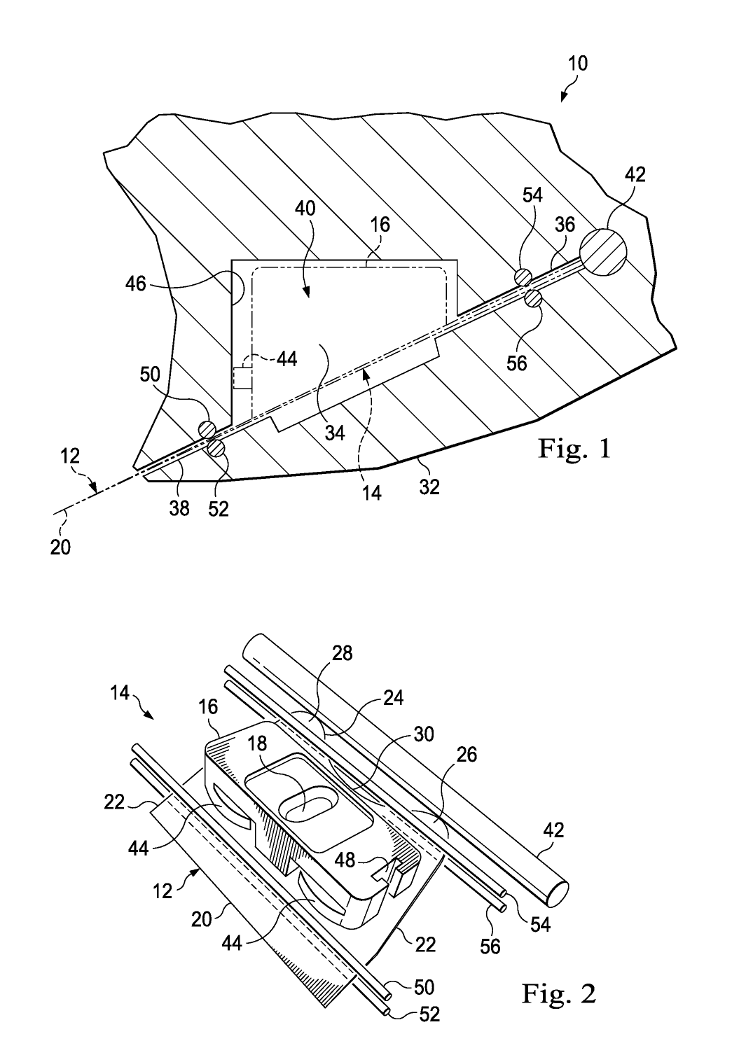

The cutting blade holder shown in section in FIG. 1, and generally identified there by the reference numeral 10, is movably guidedly held or can be held in a manner known per se on a suction ring unit of an ophthalmological microkeratome, which is not shown in more detail. After the suction ring unit has been placed on the eye to be operated on and held there under suction by means of a vacuum, the cutting blade holder can be moved by means of an electric motor drive, likewise not shown in more detail, in a feed direction over the cornea of the eye, whereby a cutting blade 12 (in particular FIG. 2) separates a surface flap from the cornea.

As can be seen in FIG. 2, the cutting blade 12 is part of a cutting blade unit 14, which includes in addition to the actual cutting blade 12 an attachment 16 on one of the flat sides of the blade. The attachment 16 is firmly connected to the cutting blade 12, preferably by an interlocking-type or frictional-type connection. A material-to-material connection using an adhesive is also conceivable. The attachment 16 simplifies the manipulation of the cutting blade unit 14. On its upper side remote from the blade the attachment has an elongated depression 18, in which an eccentric pin of a drive shaft of the aforementioned electric motor drive engages during operation of the microkeratome. The cutting blade unit 14 on rotation of the motor drive shaft is thereby caused to execute laterally oscillating movements (transverse to the feed direction), which improves the cutting action.

The cutting blade 12 forms a cutting edge 20 on a straight front blade edge. Blunt lateral blade edges 22 adjoin the front blade edge and transform in the rear region of the cutting blade 12 into a rear blade edge 24. The rear blade edge 24 is designed having two rounded bearing sections 26, 28 spaced apart from one another, between which is arranged a blade edge section 30 that is set back.

The cutting blade holder 10 comprises a base body 32, in which is formed a receptacle shaft 34 for the cutting blade unit 14. The receptacle shaft 34 is open on one side of the cutting blade holder 10, so that the cutting blade unit 14 can be inserted, transversely to the longitudinal direction of the blade (the longitudinal direction of the blade runs in this connection between the cutting edge 20 and the rear blade edge 24), into the receptacle shaft 34 and can be removed therefrom after use. The receptacle shaft 34 has two slit-shaped sections 36, 38, between which is located an enlarged section 40. When the cutting blade unit 14 is inserted into the receptacle shaft 34 the attachment 16 extends into the enlarged section 40, while the blade regions in front and behind the attachment 16 extend into the slit-shaped shaft sections 36, 38. If the cutting blade unit 14 is inserted correctly into the receptacle shaft 34, as indicated by the dotted lines in FIG. 1, then the cutting blade 12 with its cutting edge 20 projects from the cutting blade holder 10. At the same time the cutting blade 12 with its rear edge sections 26, 28 is supported on a guide bearing bar 42 held in the base body 32.

The guide bearing bar 42 shown by way of example in FIGS. 1 and 2 has a circular cross-section and with its outer circumferential surface consequently forms a convex guide bearing surface for the sections 26, 28 of the rear blade edge 24. In order to provide a convex, arcuately curved guide bearing surface the guide bearing bar 42 can also have a cross-sectional shape other than a circular shape, and can for example be elliptical or oval.

On account of the rounded shape of the bearing sections 26, 28 the contact between the cutting blade and the guide bearing bar 42 is virtually punctiform. This ensures a particularly low degree of friction when the cutting blade 14 oscillates laterally during operation of the microkeratome. The small amount of friction is also promoted by the convex shape of the guide bearing surface formed by the guide bearing bar 42. Instead of an arcuately curved contour of the guide bearing surface, it is even conceivable for the guide bearing surface to have an approximately cone-shaped contour seen in a cross-section perpendicular to the transverse direction of the blade. This possibility will be discussed again at a later point.

In FIG. 2 it can be seen that the attachment 16 is designed with two spring tongues, which are intended and designed to co-operate with a front boundary wall 46 of the enlarged shaft section 40. The spring tongues 44 pretension the cutting blade unit 14 in the rearwards direction, i.e. against the guide bearing bar 42, when the cutting blade unit 14 is correctly inserted into the receptacle 34.

An undercut T-shaped groove 48, with which an actuating rod (not shown in more detail) can be brought into feed-transmitting and tensile force-transmitting engagement, is formed on the side of the attachment 16, which for example can be injection moulded from plastics material but can also be made from metal or a ceramic material. By means of such an actuating rod the cutting blade unit 14 can be inserted without any problem into the receptacle 14 and/or removed from the latter.

In the embodiment illustrated in FIGS. 1 and 2, two pairs of guide bars 50, 52 and 54, 56, which are incorporated in the base body 32 of the blade cutting holder 10 parallel to the guide bearing bar 42, i.e. in the direction of the lateral oscillation of the cutting blade unit 14, serve for the relatively low-friction but at the same time precise guidance of the cutting blade 12 in its oscillatory movement. The guide bars 50-56 form in each case a guide formation within the meaning of the invention and, like the guide bearing bar 42, are made of a particularly abrasion-resistant material, which has a greater hardness than the material of the base body 32. Preferably the bars 42 and 50-56 are hard metal bars. The base body 32 of the cutting blade holder can on the other hand be made for example of stainless steel or titanium. The guide bars 50-56 are arranged in the region of the slit-shaped shaft sections 36, 38 specifically in such a way that with each of these slit-shaped sections 36, 38 there is associated a pair of bars lying substantially opposite one another. Although it is not immediately clear from FIG. 1, the guide bars 50-56 on part of their circumference extend to some extent into the slit-shaped shaft sections 36, 38, so that the cutting blade 12 comes into contact on its flat sides alone with the outer circumferential surfaces of the guide bars 50-56, but not with the upper and lower boundary walls of the slit-shaped shaft sections 36, 38. The contact between the guide bars 50-56 and the flat sides of the cutting blade 12 is in this case linear in the technical sense (in contrast to a planar bearing), which ensures a low degree of friction. As FIGS. 1 and 2 show, one pair of guide bars, namely the pair 54, 56, is arranged behind the attachment 16 of the cutting blade 12, while the other pair of bars, i.e. the pair 50, 52, is arranged in front of the attachment 16. The bars 50-56 and also the guide bearing bar 42 can be inserted in correspondingly shaped channels of the base body 32.

To produce the aforementioned linear contact with the cutting blade 12, the guide bars 50-56 have convex guide surfaces, which project into the slit-shaped shaft sections 36, 38. In the example illustrated in FIGS. 1 and 2 the guide bars 50-56 are designed so as to form these convex guide surfaces with a circular cross-section. It is understood that other cross-sectional shapes can be chosen for the guide bars 50-56, so long as they have a convex shape in the bearing region of the cutting blade 12. For example, an elliptical or oval cross-sectional shape can be chosen for the guide bars 50-56; they can however also have a cone-shaped cross-sectional contour in the region of the contact with the cutting blade 12.

In a modification of the embodiment shown in FIGS. 1 and 2, the base body 32 itself can be designed having ribs formed in one piece, which replace the segments of the guide bars 50-56 projecting into the slit-shaped shaft sections 36, 38. Also, the convex guide bearing surface formed from the guide bearing bar 42 for the rear blade edge 24 of the cutting blade 12 can if required be formed in one piece on the base body 32. The provision of separate bars for the guidance of the cutting blade 12 is however advantageous insofar as the bars can be replaceably incorporated in the cutting blade holder 10, so that individual rods can be replaced when worn out.

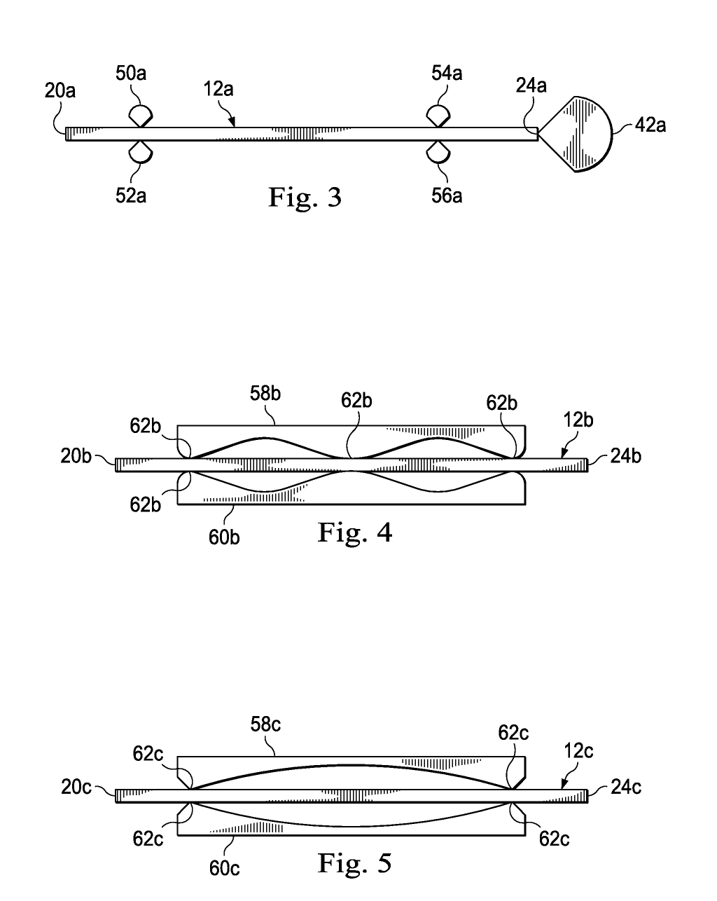

Reference will now be made to the modifications shown diagrammatically in FIGS. 3 to 5. In these figures components having the same effect are identified by the same reference numerals as before, but with the addition of a lower case letter.

In a variant of FIG. 3 the guide bars 50a-56a as well as the guide bearing bar 42a are formed in each case having a cone-shaped contour in the region of the contact with the cutting blade 12a. Apart from the cross-sectional shape of the bars illustrated in this figure, the bars can for example also have a triangular or rectangular cross-sectional shape.

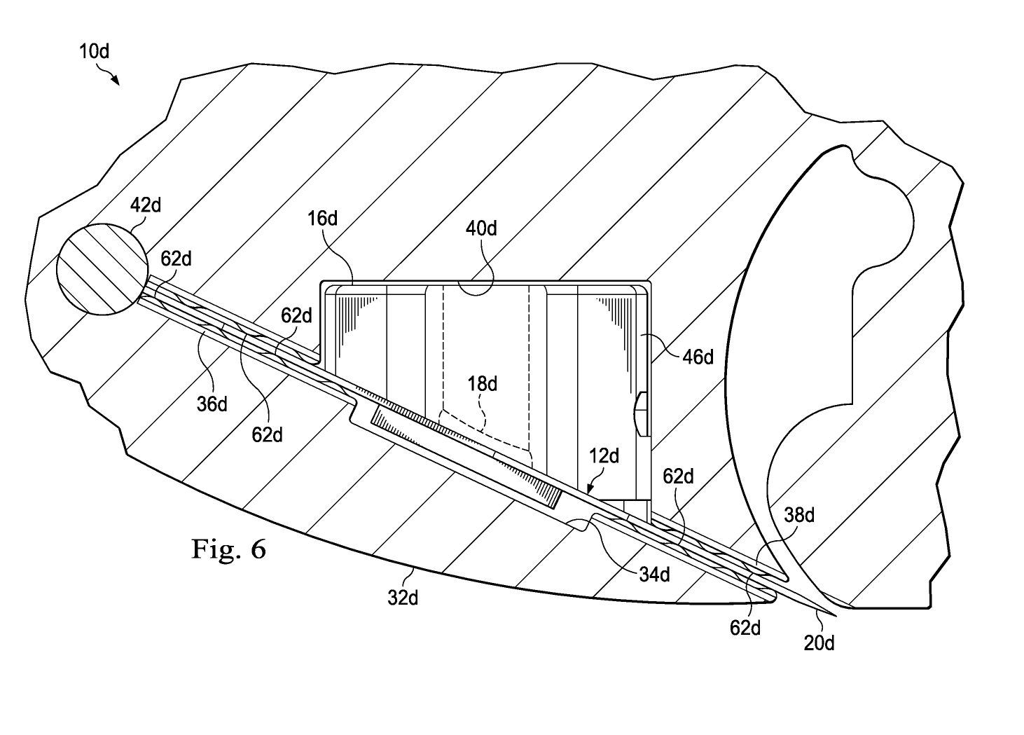

FIGS. 4 and 5 show variants in which several guide formations for the cutting blade are formed in each case on a common guide body. In FIG. 4 two guide plates 58b, 60b are arranged above and below the cutting blade 12b. The guide plates 58b, 60b replace the guide bars 50-56 of the embodiment shown in FIGS. 1 and 2. The plates are designed with rib-shaped guide bearing sections 62b on their plate side facing towards the cutting blade 12b, these sections appearing round when viewed as in FIG. 4, i.e. viewed in a cross-section transverse to the transverse direction of the blade. On account of the round contour of the guide bearing sections 62b an approximately linear contact with the flat sides of the cutting blade 12b is in turn formed. In the variant of FIG. 4 the two guide plates 58b, 60b have in each case a total of three guide bearing sections 62b, these sections lying opposite one another in pairs. The guide plates 58b, 60b can for example be inserted in suitable recesses of the base body of the cutting blade holder.

The variant of FIG. 5 differs from that of FIG. 4 in that the guide plates 58c, 60c comprise in each case only two guide bearing sections 62c, and that these guide bearing sections 62c have a cone-shaped contour in the contact region with the cutting blade 12c.

It is understood that embodiments are also conceivable in which one or more guide bars are provided on one side of the cutting blade, while a guide body is provided on the other side of the cutting blade, the said body carrying a plurality of guide formations arranged space apart from one another, such as for example the guide plates of FIGS. 4 and 5.

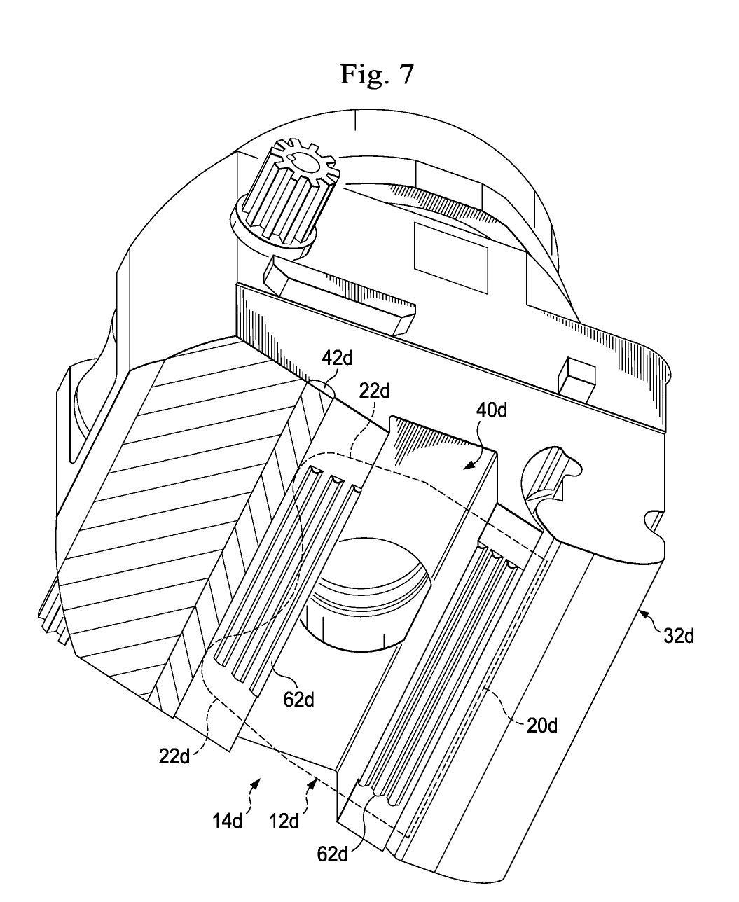

Also, in the embodiment of FIGS. 6 and 7 identical components or components having the same effect are again identified with the same reference numerals as before, but in each case with the addition of a lower case letter d. In this embodiment the cutting blade holder 10d is provided on both sides of the plane of the cutting blade 12d with in each case a plurality of guide ribs 62d, which run parallel to one another and extend in the transverse direction of the blade. The guide ribs 62d are, as can readily be seen in FIG. 6, arranged alternately on both sides of the plane of the blade, and in fact in such a way that a guide rib 62d on one side of the plane of the blade lies substantially centrally between two guide ribs 62d on the other side of the plane of the blade. The guide ribs 62d can be formed in one part with the base body 32d of the cutting blade holder 10d. Alternatively, the guide ribs 62d can be formed on separate guide bodies, which are mounted on the base body 32d. These guide bodies can be joined to the base body 32d in a permanent manner, for example by bonding or pressing in. It is however also conceivable to attach the base bodies in a replaceable manner to the base body 32d, so that they can be replaced due to wear. As already mentioned above in connection with the variants of FIGS. 4 and 5, such guide bodies can for example be in the form of thin plates, from which the guide ribs stand proud in one piece.

In FIG. 7, in which the cutting blade 12d is indicated by dotted lines in a middle position, it can be seen that the length of the guide ribs 62d is less than the width of the cutting blade 12d. The lateral oscillation stroke of the cutting blade 12d is in this connection adjusted so that the lateral blade edges 22d do not reach beyond the guide ribs 62d in the cutting operation of the blade. In this way a potential chip abrasion on the side edges 22d of the blade can be avoided.

For the sake of completeness it should be mentioned that, in the illustration of FIG. 7, the lower part of the base body 32d recognisable in FIG. 6 has been omitted for the sake of clarity.

What is claimed is:

1. Cutting blade holder for a microsurgical cutting arrangement, in particular a cutting arrangement for refractive eye surgery, in which the cutting blade holder comprising:
a cutting blade holder body having a receptacle into which a cutting blade unit with a cutting blade can be inserted; and
wherein in addition the cutting blade holder body comprises guide means for the sideways movement guidance of the cutting blade unit in the receptacle, characterised in that the guide means include guide formations arranged on both sides of the plane of the blade of the cutting blade, which formations produce an approximately punctiform or linear contact with the cutting blade.

2. Cutting blade holder according to claim 1, characterised in that at least one guide formation is formed by a guide bar extending in the transverse direction of the blade and held on a base body of the cutting blade holder body.

3. Cutting blade holder according to claim 1, characterised in that several guide formations are formed in one piece on a common guide body of the cutting blade holder body.

4. Cutting blade holder according to claim 1, characterised in that at least one guide formation has, viewed in a cross-section transverse to the transverse direction of the blade, an arcuately curved contour in the region of a guide bearing point.

5. Cutting blade holder according to claim 1, characterised in that at least one guide formation has, viewed in a cross-section transverse to the transverse direction of the blade, a cone-shaped contour in the region of a guide bearing point.

6. Cutting blade holder according to claim 1, characterised in that at least one pair of guide formations arranged on both sides of the plane of the blade lie at least approximately opposite one another when viewed in a cross-section transverse to the transverse direction of the blade.

7. Cutting blade holder according to claim 1, characterised in that a plurality of guide formations are arranged alternately on both sides of the plane of the blade when viewed in a cross-section transverse to the transverse direction of the blade.

8. Cutting blade holder according to claim 1, characterised in that the guide means associated with each of the flat sides of the cutting blade include at least two guide formations arranged spaced apart from one another in the longitudinal direction of the blade.

9. Cutting blade holder according to claim 8, characterised in that the guide means include two guide formations, which when the cutting blade unit is correctly inserted into the receptacle are arranged on both sides of a blade attachment on one of the flat sides of the blade, in the longitudinal direction of the blade.

10. Cutting blade holder according to claim 1, characterised in that the guide formations are provided in a region, the extension of which in the transverse direction of the blade is less than that of a cutting blade designed and intended for use with the cutting blade holder.

11. Cutting blade holder according to claim 1, characterised in that the guide means include a guide bearing surface intended for supporting the cutting blade on a rear blade edge, the said surface having a convex contour when viewed in a cross-section transverse to the transverse direction of the blade.

12. Cutting blade holder according to claim 1, characterised in that the cutting blade holder body is formed of a first material and the guide means are formed from one or more guide bodies formed of a second material harder than the first material.
